(19) United States
(12) Patent Application Publication
(10) Pub. No.: US 2015/0226689 A1
(43) Pub. Date: Aug. 13, 2015

(54) ELECTROCHEMICAL ARTICLE AND PROCESSES FOR MAKING SAME AND MAKING ELECTROCHEMICAL MEASUREMENTS

(71) Applicants: HERMAN O. SINTIM, (US); NATIONAL INSTITUTE OF STANDARDS AND TECHNOLOGY, GAITHERSBURG, MD (US)

(72) Inventors: Stephen Semancik, GAITHERSBURG, MD (US); HERMAN O. SINTIM, BOWIE, MD (US)

(21) Appl. No.: 14/692,896

(22) Filed: Apr. 22, 2015

Related U.S. Application Data
(60) Provisional application No. 61/996,658, filed on May 14, 2014.

(51) Int. Cl. G01N 27/28

(52) U.S. Cl. CPC G01N 27/28

(57) ABSTRACT

An electrochemical article includes: a substrate; a working electrode disposed on the substrate to contact a composition that includes: a fluid; and an analyte to adsorb to the working electrode and comprising an electroactive moiety, the reference electrode being configured to receive a plurality of electrons from the electroactive moiety, to donate electrons to the electroactive moiety, or a combination thereof; a reference electrode disposed on the substrate to contact the fluid; a counter electrode disposed on the substrate to contact the fluid; a heater disposed on the substrate to heat the analyte adsorbed on the working electrode to a selected temperature; and an electrically insulating layer interposed between the heater and the working electrode, the electrochemical article being microfabricated. A process for process for performing electrochemistry includes: introducing a composition to the electrochemical article; and transferring a plurality of electrons between the working electrode and the electroactive moiety to perform electrochemistry.

### STATEMENT REGARDING FEDERALLY SPONSORED RESEARCH

This invention was made with United States government support from the National Institute of Standards and Technology. The government has certain rights in the invention.

### BRIEF DESCRIPTION

Disclosed is an electrochemical article comprising: a substrate; a working electrode disposed on the substrate to contact a composition comprising: a fluid; and an analyte to adsorb to the working electrode and comprising an electroactive moiety, the reference electrode being configured to receive a plurality of electrons from the electroactive moiety, to donate electrons to the electroactive moiety, or a combination comprising at least one of the foregoing exchanges of electrons with the electroactive moiety; a reference electrode disposed on the substrate to contact the fluid; a counter electrode disposed on the substrate to contact the fluid; a heater disposed on the substrate to heat the analyte adsorbed on the working electrode to a selected temperature; and an electrically insulating layer interposed between the heater and the working electrode, the electrochemical article being microfabricated.

Further disclosed is an electrochemical article comprising: a substrate; a working electrode disposed on the substrate to contact a composition comprising: a fluid; and an analyte to adsorb to the working electrode and comprising an electroactive moiety, the reference electrode being configured to receive a plurality of electrons from the electroactive moiety, to donate electrons to the electroactive moiety, or a combination comprising at least one of the foregoing exchanges of electrons with the electroactive moiety; a reference electrode disposed on the substrate to contact the fluid; a counter electrode disposed on the substrate to contact the fluid; a heater disposed on the substrate to heat the analyte adsorbed on the working electrode to a selected temperature; an electrically insulating layer interposed between the heater and the working electrode, the electrochemical article being microfabricated; and a microfluidic system comprising: a container disposed on the substrate to receive and to hold the composition in contact with the working electrode, the reference electrode, and the counter electrode; and a fluid delivery system in fluid communication with the container to deliver the composition to the container, the microfluidic system being configured to deliver a microfluidic volume of the composition to the working electrode, the reference electrode, and the counter electrode.

Also disclosed is a process for performing electrochemistry, the process comprising: introducing a composition to an electrochemical article that comprises: a substrate; a working electrode disposed on the substrate, the composition comprising: a fluid; and an analyte comprising an electroactive moiety; a reference electrode disposed on the substrate; a counter electrode disposed on the substrate; a heater disposed on the substrate; and an electrically insulating layer interposed between the heater and the working electrode; and transferring a plurality of electrons between the working electrode and the electroactive moiety to perform electrochemistry.

Further disclosed is a process for performing electrochemistry, the process comprising: adsorbing a first probe on an electrochemical article comprising: a substrate; a working electrode disposed on the substrate; a reference electrode disposed on the substrate; a counter electrode disposed on the substrate; a heater disposed on the substrate opposing the working electrode, the reference electrode, and the counter electrode; and an electrically insulating layer interposed between the heater and the working electrode; forming an analyte by contacting the first probe with a second probe comprising an electroactive moiety; and transferring a plurality of electrons between the working electrode and the electroactive moiety to perform electrochemistry.

### BRIEF DESCRIPTION OF THE DRAWINGS

The following descriptions should not be considered limiting in any way. With reference to the accompanying drawings, like elements are numbered alike:

FIGS. 1A and 1B respectively show a top view (FIG. 1A) and a cross-section (FIG. 1B) of an embodiment of an electrochemical article;

FIG. 2A shows an optical micrograph of a top view of an embodiment of an electrochemical article;

FIG. 2B shows an enlarged view of the electrochemical article shown in FIG. 2A;

FIG. 2C shows a heater of the electrochemical article shown in FIGS. 2A and 2B;

FIG. 2D shows an enlarged view of the heater shown in FIG. 2C;

FIG. 2E shows a working electrode, reference electrode, and counter electrode of the electrochemical article shown in FIGS. 2A and 2B;

FIG. 2F shows a cross-section along line A-A of the electrochemical article shown in FIG. 2B;

FIG. 2G shows a cross-section along line B-B of the electrochemical article shown in FIG. 2B;

FIG. 2H shows a cross-section along line C-C of the electrochemical article shown in FIG. 2B;

FIG. 3 shows a plurality of electrochemical articles;

FIG. 4A shows a perspective view of an embodiment of an electrochemical article;

FIG. 4B shows an exploded view of the electrochemical article shown in FIG. 4A;

FIG. 5A shows a perspective view of an embodiment of an electrochemical article;

FIG. 5B shows an exploded view of the electrochemical article shown in FIG. 5A;

FIG. 6 shows an embodiment of an array of electrochemical articles;

FIG. 7 shows an embodiment of a system;

FIGS. 8A, 8B, 8C, 8D, 8E, 8F, 8G, 8H, 8I, 8J, 8K, 8L, and 8M show cross-sections of a substrate and structure formed in a process for making an electrochemical article;

FIGS. 9A, 9B, and 9C show an analyte adsorbed on a working electrode of an electrochemical article;

FIG. 10 shows a graph of current versus distance for the analytes shown in FIGS. 9A, 9B, and 9C;

FIGS. 11A, 11B, 11C, and 11D show adsorption of an analyte on a reference electrode;

FIG. 12 shows a graph of current versus potential for the analyte shown in FIGS. 11A, 11B, 11C, and 11D;

FIGS. 13A, 13B, and 13C show an analyte adsorbed on a working electrode of an electrochemical article;

FIGS. 14A, 14B, and 14C show an analyte adsorbed on a working electrode of an electrochemical article;

FIG. 15 shows a graph of current versus temperature for the analytes shown in FIGS. 14A, 14B, and 14C;

FIGS. 16A, 16B, 16C, and 16D show a probe adsorbed on a working electrode of a an electrochemical article;

FIG. 17 shows a graph of current versus temperature for analytes shown in FIGS. 16A, 16B, 16C, and 16D;

FIGS. 18A and 18B show an analyte adsorbed on a working electrode of an electrochemical article;

FIG. 19 shows a graph of current versus temperature for analytes shown in FIGS. 18A and 18B; and

FIG. 20 shows a graph of current versus temperature for an analyte adsorbed on a working electrode of an electrochemical article according to Example 2.

### DETAILED DESCRIPTION

A detailed description of one or more embodiments is presented herein by way of exemplification and not limitation.

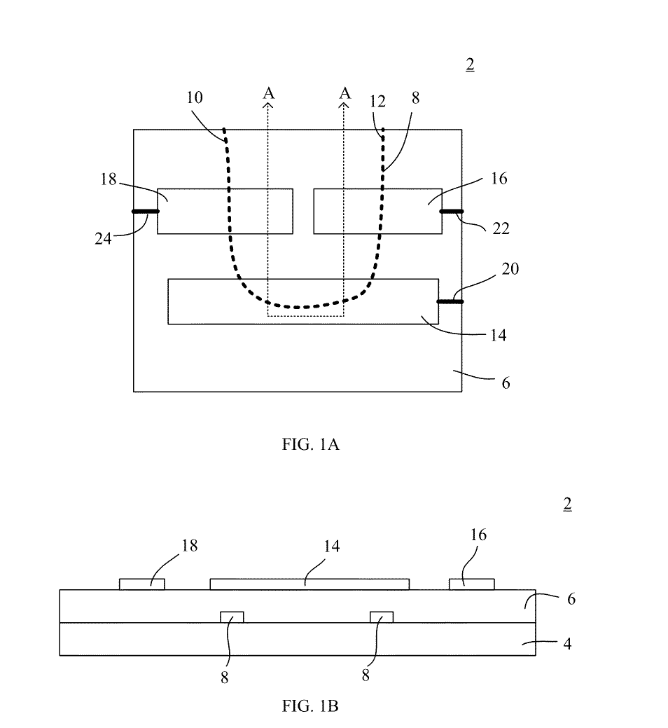

In an embodiment, as shown in FIG. 1A (top view of electrochemical article 2) and FIG. 1B (cross-section of electrochemical article 2 along line A-A shown in FIG. 1A), electrochemical article 2 includes heater 8 disposed on substrate 4. Insulator 6 is interposed between heater and working electrode 14 disposed thereon. Counter electrode 16 and reference electrode 18 are disposed on insulator 6 proximate to working electrode 14. Wiring (20, 22, 24) respectively optionally electrically connects working electrode 14, counter electrode 16, or reference electrode 18 to a power source or a readout electronic to provide voltage or current to the electrode (14, 16, or 18) or to measure a current or an electrical potential of the electrode (14, 16, or 18). Heater 8 is configured to heat working electrode 14, counter electrode 16, and reference electrode 18 to a selected temperature as well as a fluid or analyte in contact with working electrode 14, counter electrode 16, or reference electrode 18. Additionally, heater 8 includes first end 10 and second end 12 through which an electrical current can be provided to heater 8. Insulator 6 is provided to electrically insulate heater 8 and working electrode 14, counter electrode 16, and reference electrode 18.

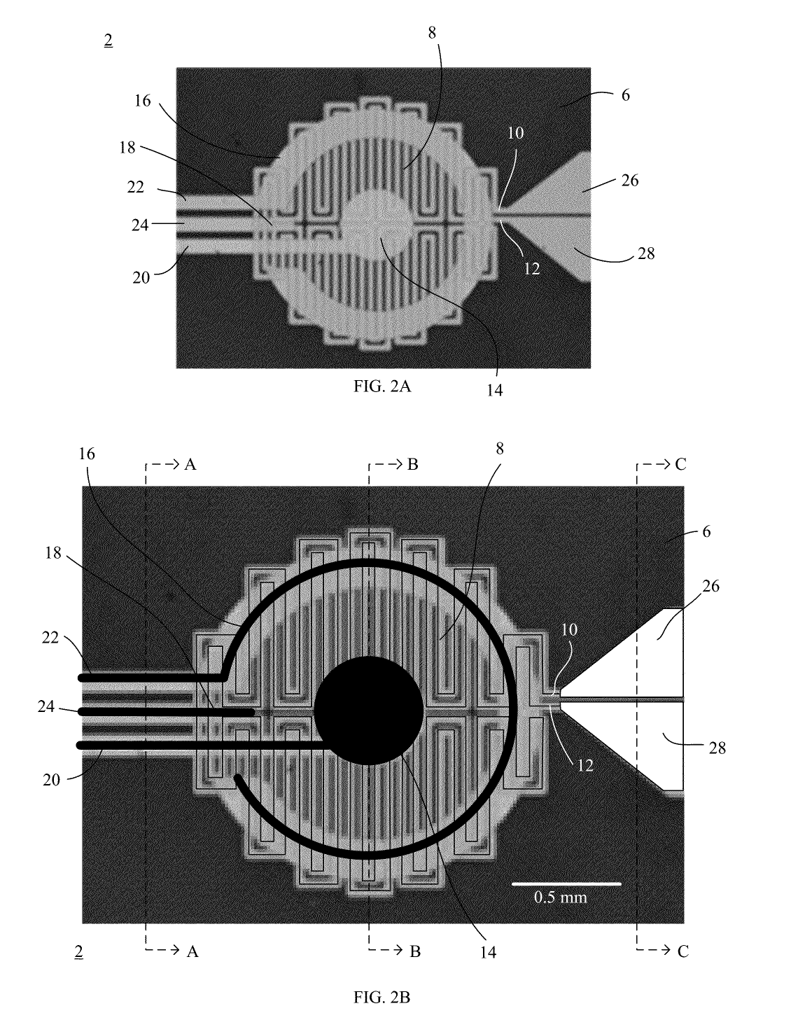

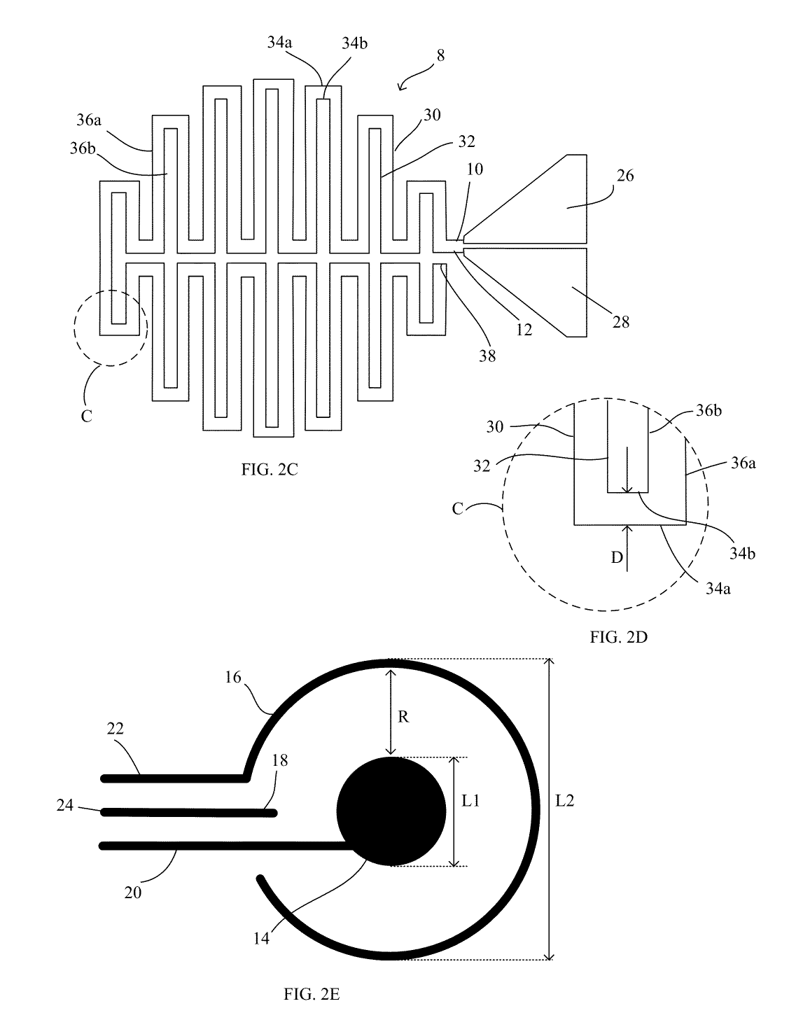

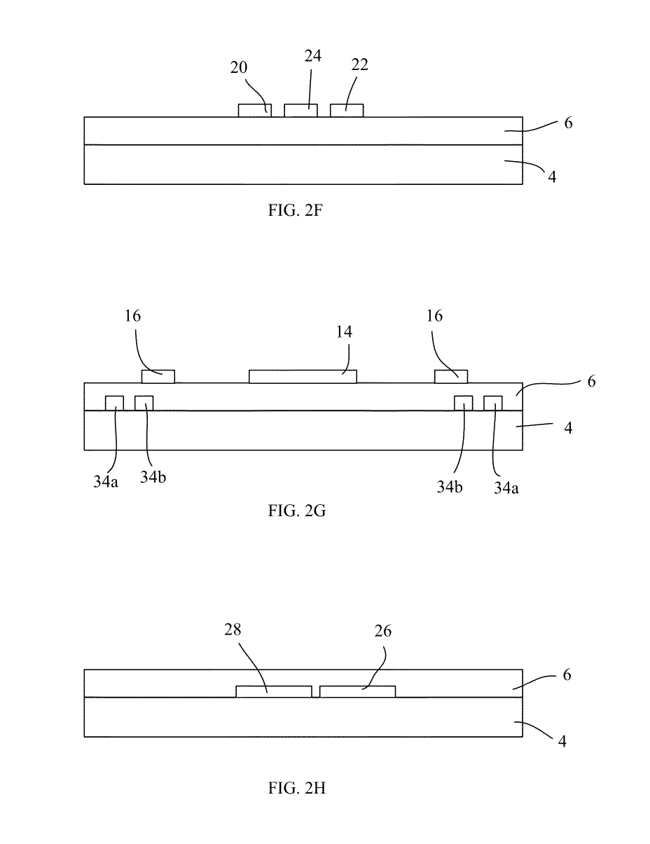

An optical micrograph of a top view of an embodiment of article 2 is shown in FIG. 2A. Insulator 6 is interposed between heater 8 and working electrode 14, counter electrode 16, and reference electrode 18, and heater 8 is visible through electrodes (14, 16, 18) and insulator 6. Contact pad 26 is electrically connected to first end 10 of heater 8, and contact pad 28 is electrically connected to second end 12 of heater 8. FIG. 2B shows an enlarged view of electrochemical article 2 shown in FIG. 2A. Here, heater 8 and electrodes (14, 16, 18) are marked with an overlaid line or curve.

Heater 8 can have numerous geometrical configurations with respect to electrodes (14, 16, 18) such as a loop shown in FIG. 1A or serpentine pattern shown in FIG. 2C. With reference to FIG. 2C, heater 8 includes first pattern 30 and second pattern 32 that electrically connect at connector 38. In some embodiments, first pattern 30 is an outer pattern of heater 8, and second pattern 32 is an inner pattern of heater 8. In a certain embodiment, first pattern 30 is substantially similar to second pattern 32. In a particular embodiment, first pattern 30 is different than second pattern 32, i.e., first pattern 30 and second pattern 32 can have a different shape, size (length, width, height, and the like), or a combination thereof. First pattern 30 and second pattern 30 respectively include lateral members 34a and 34b electrically connected to traverse members 36a and 36b. An enlarged view of portion C of FIG. 2C is shown in FIG. 2D. First pattern 30 is separated from second pattern 32 by distance D. According to an embodiment, first pattern 30 or second pattern 32 extend along substrate 4 such that heater 8 spans an area covered by working electrode 14, counter electrode 16, and reference electrode 18 as shown in FIG. 2A. Moreover, a shape of heater 8, for example serpentine pattern shown in FIG. 2C, can match a shape of working electrode 14, counter electrode 16, and reference electrode 18 or an area covered by working electrode 14, counter electrode 16, and reference electrode 18.

FIG. 2E shows a top view of working electrode 14, counter electrode 16, and reference electrode of the electrochemical article shown in FIGS. 2A and 2B. Here, working electrode 14 has a circular shape although other shapes (e.g., polygonal, linear, curved, annular, and the like) can be used for working electrode 14. A shape and size L1 of working electrode 14 is effective to perform electrochemistry in combination with an analyte. Counter electrode 16 is surroundingly disposed about working electrode 14. Counter electrode 16 having size L2 (e.g., an outer diameter or largest linear dimension) and working electrode 14 are separated by distance R, which can be a uniform or nonuniform distance for an entire length of counter electrode 16 relative to working electrode 14. In some embodiments, counter electrode 16 has a shape substantially similar to an outer most shape of working electrode 14. Moreover, electrochemical article 2 can include a plurality of working electrodes 14 arranged proximate to counter electrode 16 on insulator 6. Further, reference electrode 18 can have various shapes other than linear.

FIG. 2F, FIG. 2G, and FIG. 2H respectively show a cross-section along line A-A, line B-B, and line C-C of electrochemical article 2 shown in FIG. 2B. With reference to FIG. 2F, a distance between wiring 20, wiring 22, and wiring 24 can be selected based on a configuration of working electrode 14, counter electrode 16, and reference electrode 18.

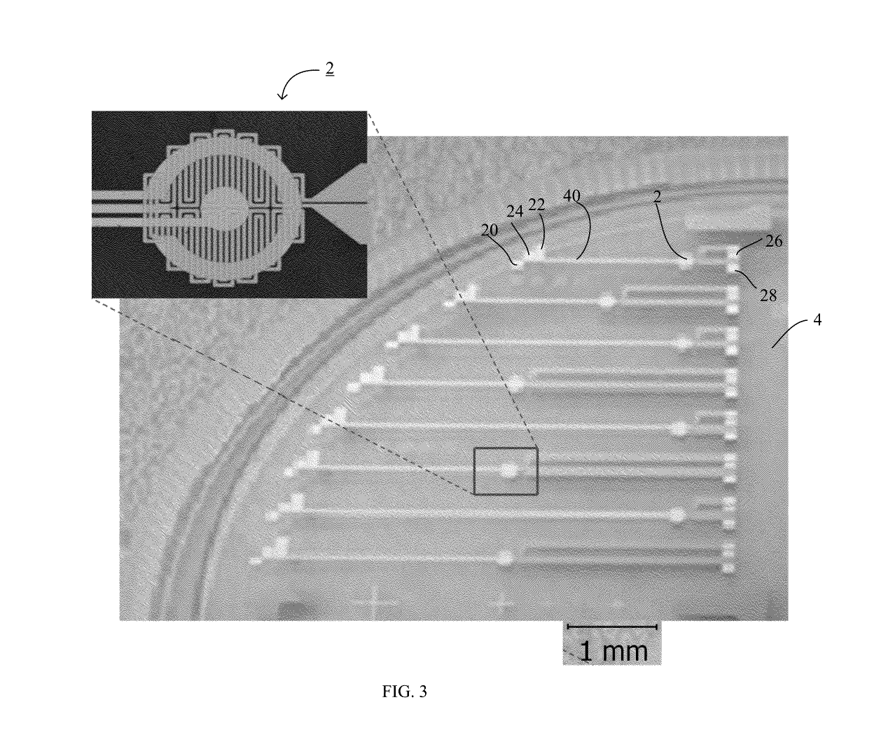

According to an embodiment, as shown in FIG. 3, a plurality of electrochemical articles 2 has a common substrate 4 such that an article can include an array of electrochemical articles 2. The plurality of electrochemical articles 2 can be arranged in various patterns and independently or individually operated for performing a plurality of electrochemical studies. Moreover, individual electrochemical articles 2 can be separated from common substrate 4 to provide a selected number of electrochemical articles 2 on substrate 4. The inset included in FIG. 3 shows an enlarged view of one of electrochemical articles 2.

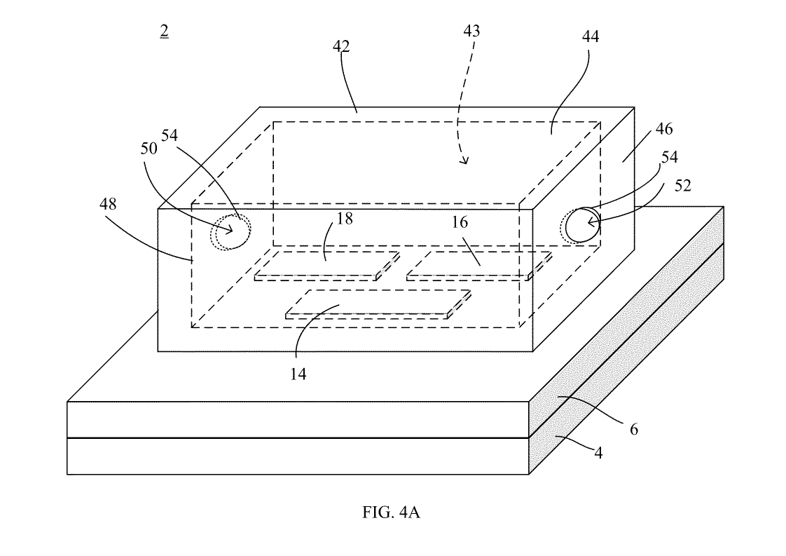

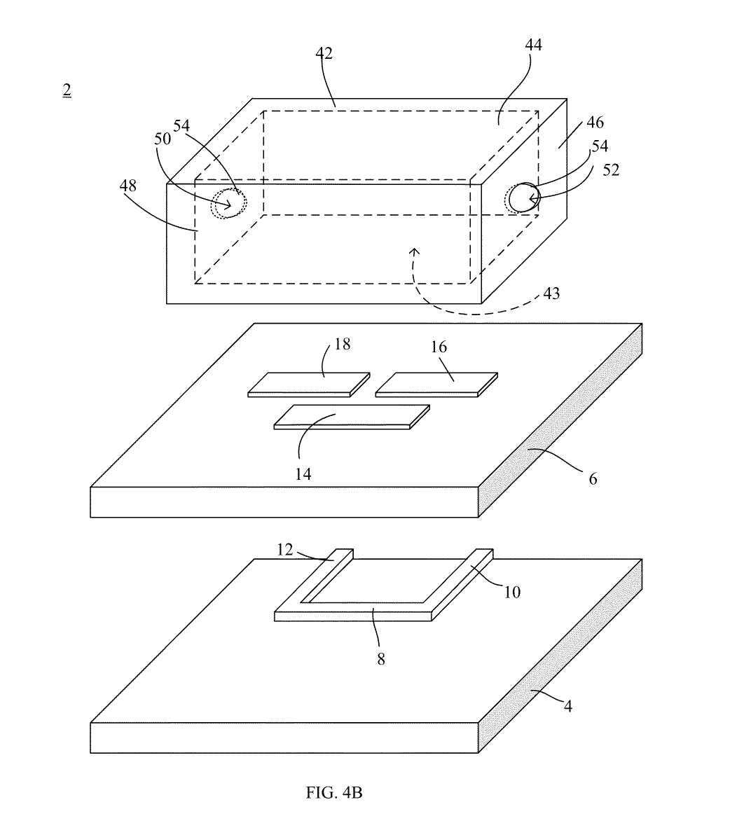

In an embodiment, electrochemical article 2 includes container 42 disposed on substrate 4. Insulator 6 can be interposed between container 42 and substrate 4. With reference to a perspective view of electrochemical article 2 shown in FIG. 4A, container 42 includes sidewall 46 having inner surface 48 that bounds and an interior volume 43 and faces working electrode 14, counter electrode 16, and reference electrode 18 among interior volume 43. Container 42 also can include top 44 such that container 42 is a closed chamber with respect to interior volume 43. In some embodiments, top 44 is absent from container 42 such that container 42 is an open chamber with respect to interior volume 43. Container 42 is configured to receive a volume of an analyte, fluid, composition, and the like, or combination thereof, which can be disposed in interior volume 43 by a delivery system (e.g., a pipette, microfluidic deliverer, and the like). Container 42 can include first aperture 50 bounded by wall 54, second aperture 52 bounded by wall 54, or combination thereof. First aperture 50 and second aperture 52 are through holes disposed in container 42 to provide fluid communication to container 42 and a source of the analyte, fluid, composition, or the like. A shape of container 42, interior volume 43, first aperture 50, and second aperture 52 are independently selected and effective such that electrochemical article 2 performs electrochemistry. FIG. 4B shows an exploded view of electrochemical article 2 shown in FIG. 4A.

According to an embodiment, electrochemical article 2 includes a microfluidic system that includes container 42 disposed on substrate 4 to receive and to hold the composition in contact with working electrode 14, counter electrode 16, and reference electrode 18. The microfluidic system also can include a fluid delivery system in fluid communication with container 42 to deliver the composition to container 42, wherein the microfluidic system is configured to deliver a microfluidic volume of the composition to working electrode 14, counter electrode 16, and reference electrode 18.

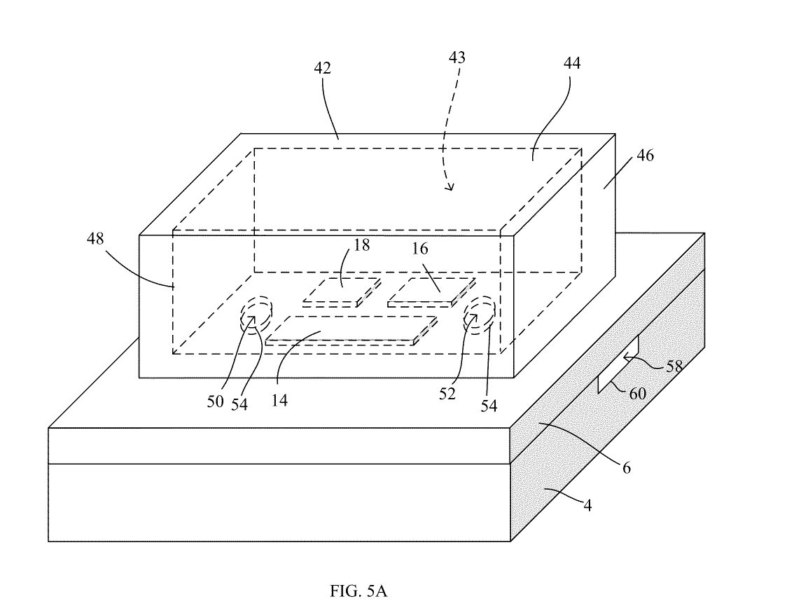

With reference to a perspective view of an embodiment of electrochemical article 2 shown in FIG. 5A and a corresponding exploded view shown in FIG. 5B, the later 6 includes first aperture 50 bounded by wall 54 and second aperture 52 bounded by wall 54 through which a composition can flow into or out of interior volume 43. Substrate 4 includes first channel 56 bounded by wall 60 that is in fluid communication with first aperture 50 to deliver the composition into interior volume 43 and electrodes (14, 16, 18). Substrate 4 also includes second channel 58 that is in fluid communication with second temperature 52 to remove the composition from interior volume 43 and from electrodes (14, 16, 18). First channel 56 and second channel 58 can be connected to a flow system for delivery and removal of the composition to electrochemical article 2.

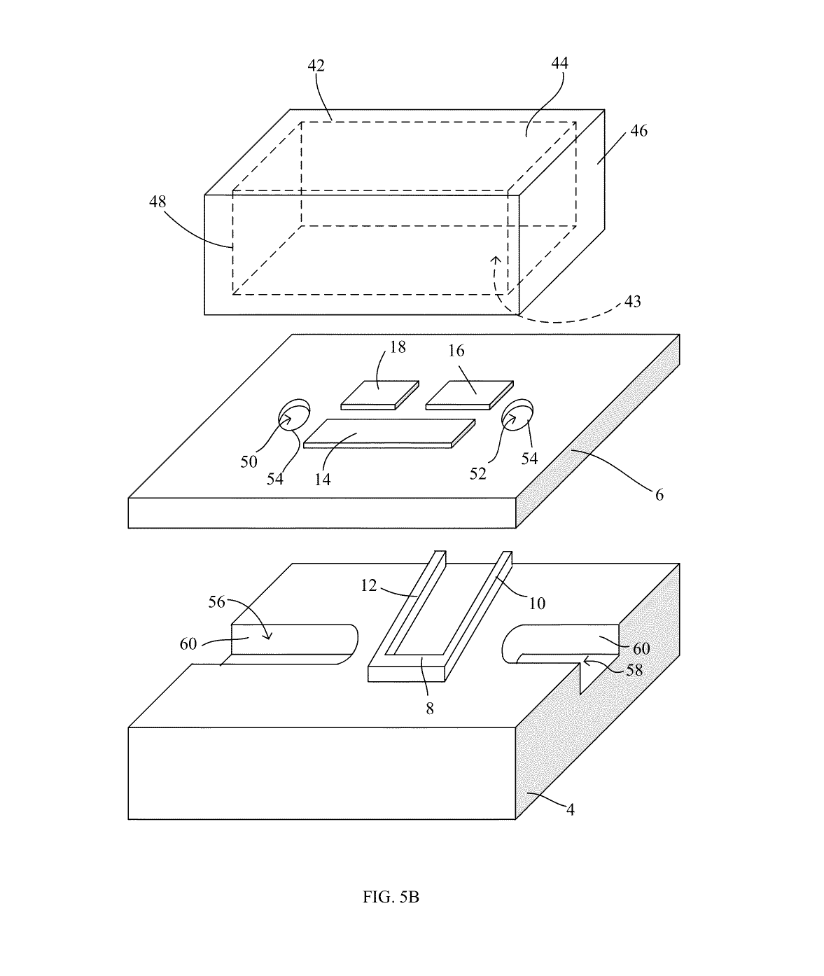

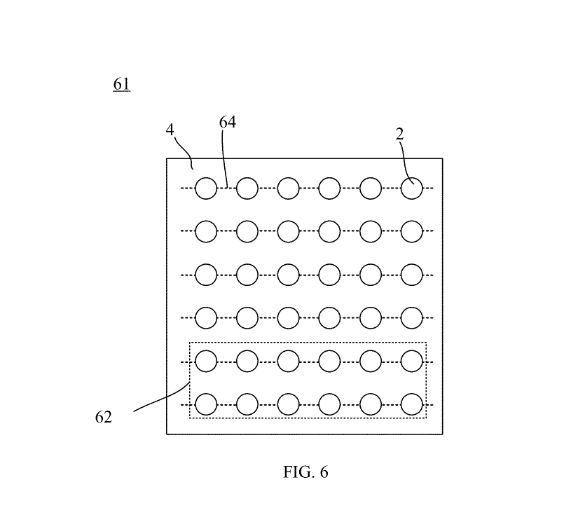

According to an embodiment, as shown in FIG. 6, article 61 includes a plurality of electrochemical articles 2 disposed on a common substrate 4 and interconnected by flow paths 64. Individual electrochemical articles 2 were in fluid communication to certain other electrochemical articles 2 of article 61 via flow paths 64. Composition can be provided to individual electrochemical articles 2 through flow paths 64. A number of electrochemical articles 2 present in article 61 form array 62 that can be selected and individually addressed electronically (e.g., heater 8, working electrode 14, counter electrode 16, reference electrode 18) to perform a plurality of electrochemical experiments in electrochemical articles 2. It is contemplated in certain embodiments, electrochemical articles 2 are independently provided with the composition such that different religion articles 2 have a same or different composition from one another.

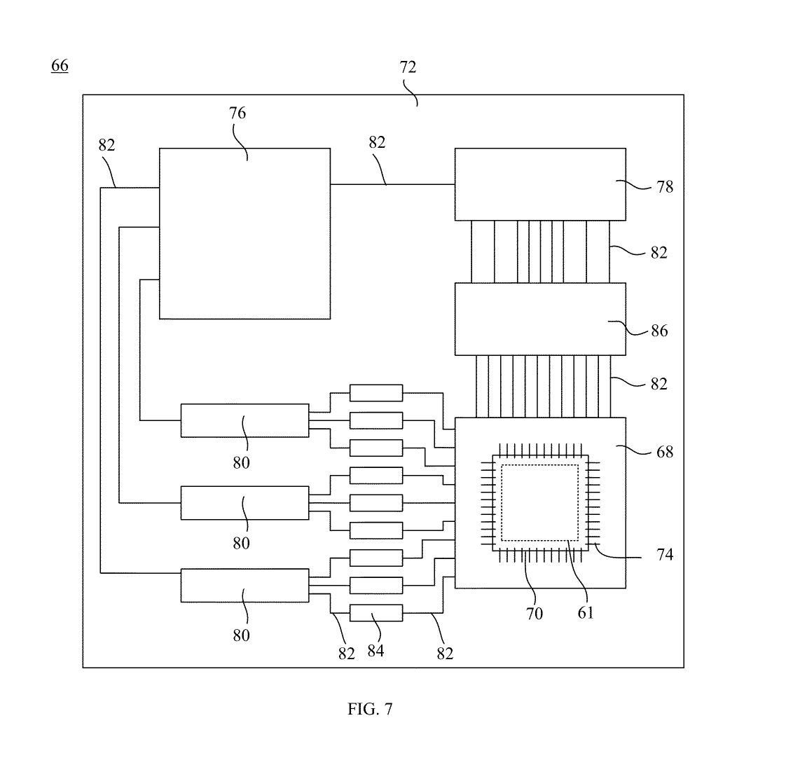

In an embodiment, as shown in FIG. 7, system 66 includes article 61 to perform controlled electrochemical experiments. Here, article 61 is disposed on area 70 of auxiliary board 68, and electrochemical articles 2 included in article 61 or electrically connected to controller 76 via electrical lines 74. Controller 76 can include a microcontroller with a processor to control heater controller 78 (e.g., a first power source) and potentiostat 80 (e.g., a second power source) through electrical lines 82. Heater controller 78 can include a power source and an amplifier to provide power to heater 8 through, e.g., heat control circuit 86 that can include a 3×3 A control circuit to address individual heaters 8 in the plurality of electrochemical articles 2 of article 61. Similarly, potentiostat 80 can be controlled to provide bias voltages to or receive electrical signals (e.g., a current or voltage) from working electrode 14, counter electrode 16, or reference electrode 18 of electrochemical articles 2 of article 61. In this manner, electrochemical articles 2 included in article 61 are configured to perform electrochemistry.

Electrochemical article 2 includes various structures such as substrate 4. Substrate 4 can be any material effective to form electrochemical article 2, e.g., by formation of heater 8 and electrodes (14, 16, 18) by microfabrication (e.g., including nanofabrication) such as lift off processing, molecular beam epitaxy, etching, and the like. Exemplary substrate 4 materials include a glass (e.g., quartz, sapphire, borosilicate, and the like), polymer (e.g., thermoplastic polymer, thermoset polymer, and the like), metal (e.g., steel, copper, gold, and the like), composite, semiconductor (silicon, germanium, compound semiconductor, nitride thereof, carbide thereof, phosphoric thereof, oxide thereof, and the like), ceramic, or a combination thereof. In a particular embodiment, substrate 4 includes a semiconductor, e.g., silicon. In an embodiment, substrate 4 includes glass. Substrate 4 is selected to withstand heating by heater 8, including cyclical heating, temperature jumps, and the like as well as providing a selected heat transfer rate or thermal conductivity, e.g., a low thermal conductivity to provide efficient heat transfer between electrodes (14, 16, 18) and heater 8. According to an embodiment, substrate 4 includes a material that reflects heat from heater 4 towards electrodes (14, 16, 18).

Heater 8 is disposed on substrate 4 and configured to heat working electrode 14, counter electrode 16, or reference electrode 18. Heater 8 produces heat, e.g., by passing current through or supplying power to heater 8. An amount of current supplied to heater 8 can be selected or controlled to achieve temperature control of heater 8. Heater 8 can include material such as platinum, tungsten, polysilicon, or a combination thereof. Heater 8 can be encapsulated in a thermally conductive material to provide electrical insulation such that such encapsulating material is interposed between heater 8 and electrodes (14, 16, 18).

Insulator 6 disposed on heater 8 electrically insulates working electrode 14, counter electrode 16, and reference electrode 18 from heater 8. A material for insulator 6 is selected to withstand heating by heater 8, including cyclical heating, temperature jumps, and the like as well as being inert to the composition, analyte, or fluid disposed thereon. Exemplary materials for insulator 6 include a glass (e.g., quartz, sapphire, borosilicate, and the like), polymer (e.g., thermoplastic polymer, thermoset polymer, and the like), composite, semiconductor (silicon, germanium, compound semiconductor, nitride thereof, carbide thereof, phosphoric thereof, oxide thereof, and the like), ceramic, or a combination thereof. In a particular embodiment, substrate four includes an oxide of the semiconductor, e.g., silicon dioxide. In his letter 6 provides fast thermal transfer between heater 8 and working electrode 14, counter electrode 16, and reference electrode 18.

Working electrode 14 is disposed on insulator 6 and configured to perform electrochemistry including exchange of electrons with the analyte, specifically electroactive moiety in the analyte. Working electrode 14 can be formed through the microfabrication process and the like. Exemplary materials for working electrode 14 include a metal such as gold, silver, platinum, carbon, an alloy thereof, or combination thereof. In an embodiment, working electrode 14 includes a gold surface on which an analyte or probe adsorbs.

In an embodiment, electrochemical article 2 includes another electrode besides working electrode 14 such as counter electrode 16. Exemplary materials for counter electrode 16 include platinum, gold, silver, carbon, an alloy thereof, or combination thereof.

In an embodiment, electrochemical article 2 includes reference electrode 18. Exemplary materials for reference electrode 18 include platinum, gold, silver, carbon, Ag/AgCl, an alloy thereof, or combination thereof. In some embodiments, counter electrode 16 and reference electrode 18 include a same material. In a certain embodiment, counter electrode 16 and reference electrode 18 include a different material.

Container 42 disposed on substrate 4 and surrounding working electrode 14, counter electrode 16, reference electrode 18 can be part of the microfluidic system or can be disposed to provide containment for disposal of the composition on working electrode 14, counter electrode 16, reference electrode 18. Exemplary materials for container 40 include poly(dimethylsiloxane) (PDMS), perfluoropolyether (PFPE), and the like. Materials for and formation of container 40 can be accomplished in various ways such as those described in U.S. patent application Ser. No. 13/859,323 filed on Apr. 9, 2013, and published as U.S. Patent Application Publication 20130228950, published Sep. 5, 2013, the content of each of which is incorporated by reference herein in its entirety.

In an embodiment, electrochemical article 2 includes substrate 4 and working electrode 14 disposed on substrate 4 to contact the composition that includes the fluid and the analyte to adsorb (e.g., by chemisorption, physisorption, and the like) to working electrode 14 and including an electroactive moiety, wherein working electrode 14 is configured to receive a plurality of electrons from the electroactive moiety, to donate electrons to the electroactive moiety, or a combination comprising at least one of the foregoing exchanges of electrons with the electroactive moiety. Electrochemical article 2 further includes reference electrode 18 disposed on substrate 4 to contact the composition, counter electrode 14 disposed on substrate 4 to contact the composition, heater 8 disposed on substrate 4 to heat the analyte adsorbed on working electrode 14 to a selected temperature, an electrically insulating layer insulator 6 interposed between heater 8 and working electrode 14. Electrochemical article 2 can be microfabricated and also include a microfluidic system that includes container 42 disposed on substrate 4 to receive and to hold the composition in contact with working electrode 14, counter electrode 16, and working electrode 18; and a fluid delivery system in fluid communication with container 42 to deliver the composition to container 42, wherein the microfluidic system is configured to deliver a microfluidic volume of the composition to working electrode 14, counter electrode 16, and reference electrode 18.

Electrochemical article 2 is configured to receive the composition that includes the analyte, a probe, a fluid, or combination thereof. The analyte or probe can be soluble or sparingly soluble in the fluid. The fluid can be a liquid such as an organic fluid or inorganic fluid. Exemplary fluids include water, an alcohol, protic solvent, polar aprotic solvent, buffer, oil, additive, crowding agent, salt, or a combination thereof.

The analyte includes the electroactive moiety. In an embodiment, the analyte is provided in the composition directly to electrochemical article 2, specifically to working electrode 14. Here, the electroactive moiety is a part of the structure of the analyte provided to electrochemical article 2. In an embodiment, the analyte is formed from a first probe included in the composition and modified in electrochemical article 2, e.g., at working electrode 14. The modification of the first probe is to combine the first probe with the electroactive moiety to form the analyte. In some embodiments, the first probe is included in the composition provided to electrochemical article 2 and adsorbs onto working electrode 14 with subsequent modification of the first probe by combination with the electroactive moiety to form the analyte adsorbed on working electrode 14. In another embodiment, the first probe is included in the composition provided to electrochemical article 2 and adsorbs onto working electrode 14 with subsequent modification of the first probe by combination with a second probe that includes the electroactive moiety to form the analyte adsorbed on working electrode 14.

Exemplary analytes include a nucleic acid (e.g., RNA, including a main class of RNA such as mRNA, snRNA, siRNA, structural RNA, microRNA, rRNA, tRNA, regulatory RNA; DNA; a base thereof; and the like), protein (e.g., a native (i.e., unmodified protein), post-translational modified protein (e.g., modified to include a group such as a sugar (e.g., an antibody), nucleotide, phosphate, fatty acid; and the like), carbohydrate, metabolite, a signaling molecule from a prokaryote or eukaryote (e.g., a second messenger, disease biomarker, and the like), drug, nutrient, and the like.

Exemplary probes include a nucleic acid, peptide, protein, polymer (synthetic or naturally occurring), receptor, small molecule, modified or unmodified version thereof, and the like.

Exemplary first probes include a nucleic acid, peptide, protein, polymer (synthetic or naturally occurring), receptor, small molecule, modified or unmodified version thereof, and the like.

Exemplary second probes include a nucleic acid, peptide, protein, polymer (synthetic or naturally occurring), receptor, small molecule, modified or unmodified version thereof, and the like.

Exemplary electroactive moieties include methylene blue, porphyrin (metallated or non-metallated), catechol, flavin, aniline, ferrocene, electroactive metal bound to a receptor (such as Cu, Ni, Os), and the like.

The analyte, probe, or first probe is adsorbed onto working electrode 14 (or counter electrode 16 or reference electrode 18) with, e.g., a linker, by chemisorption or physisorption. The linker can be a chemical bond or electrostatic attraction, e.g., hydrogen bonding or other positive charge attraction between working electrode 14 and analyte, probe, or first probe. The linker can be part of the analyte, probe, or first probe or can be formed by reacting the analyte, probe, or first probe with an agent to form a functional group or to bond the working electrode 14 to the analyte, probe, or first probe. Exemplary linkers include a sulfide bond, covalent bond, and the like between the analyte, probe, or first probe. According to an embodiment, the analyte, probe, or first probe is derivatized to include a functional group that is bonded to working electrode 14.

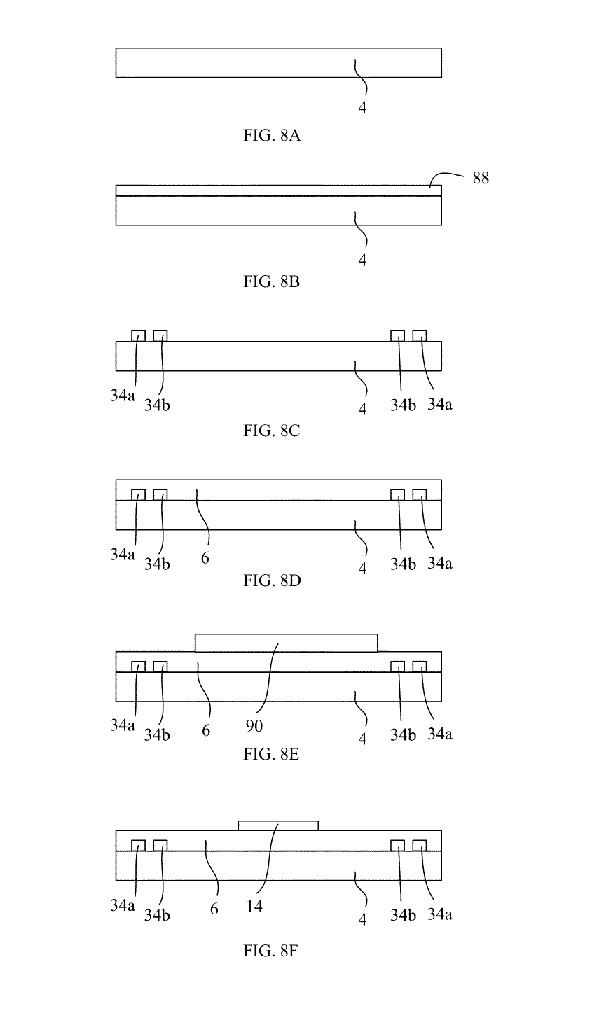

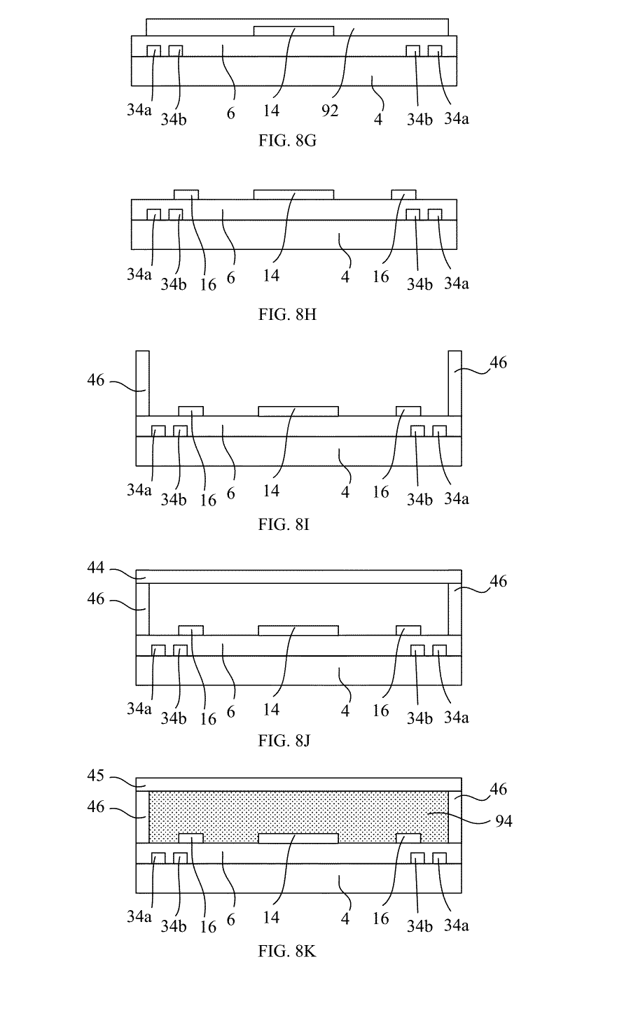

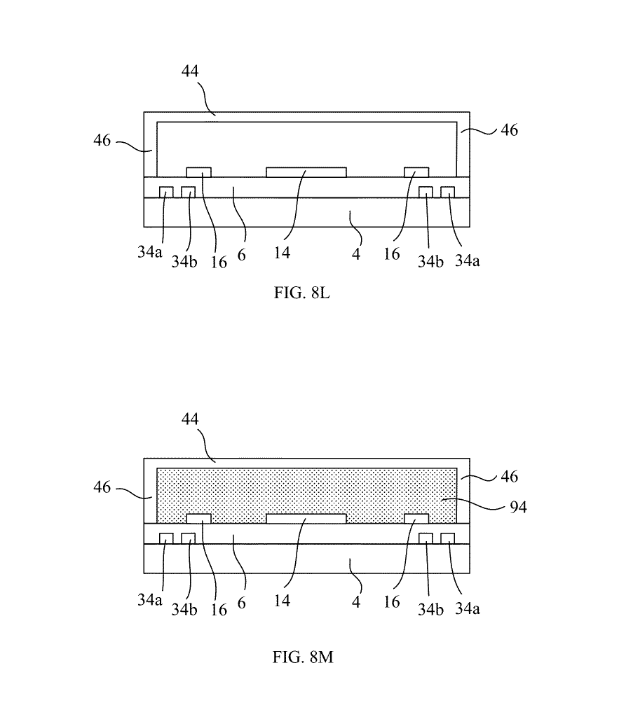

Article 2 can be made in various ways. According to an embodiment, with reference to cross-sections show in FIGS. 8A, 8B, 8C, 8D, 8E, 8F, 8G, 8H, 8I, 8J, 8K, 8L, and 8M, a process for making article 2 includes forming or providing substrate 4 (FIG. 8A), disposing heater sacrificial layer 88 on substrate 4 (FIG. 8B), patterning heater sacrificial layer 88 (e.g., etching) to create an inverse pattern for heater 8, disposing material for heater 8 in the inverse pattern to create heater 8, removing sacrificial layer 88 (FIG. 8C), disposing insulator 6 (e.g., by chemical vapor deposition) on heater 8 (FIG. 8D), disposing first electrode sacrificial layer 90 on insulator 6 (FIG. 8E), patterning first electrode sacrificial layer 90 (e.g., etching) to create an inverse pattern for working electrode 14, disposing material for working electrode 14 in the inverse pattern to create working electrode 14, removing first electrode sacrificial layer 90 (FIG. 8F), disposing second electrode sacrificial layer 92 on insulator 6 and working electrode 14 (FIG. 8G), patterning second electrode sacrificial layer 92 (e.g., etching) to create inverse patterns for counter electrode 16 and reference electrode 18, disposing material for counter electrode 16 and reference electrode 18 in the inverse patterns to create counter electrode 16 and reference electrode 18, and removing second electrode sacrificial layer 92 (FIG. 8H) to form electrochemical article 2.

According to an embodiment, the electrochemical article 2 includes container 42 that can be made by disposing wall 46 on substrate 4 as shown in FIG. 8I. Container 42 can include top 44 made by disposing top 44 on wall 46 is shown in FIG. 8J. Here, electrochemical article 2 is configured to receive composition 94 as shown in FIG. 8K. In some embodiments, electrochemical article 2 shown in FIG. 8H is subjected to forming container 42 that includes wall 46 and top 44 as a monolithic structure (FIG. 8L), e.g., a microfluidic container, which is configured to receive composition 94 as shown in FIG. 8M. In a particular embodiment, first aperture 50 or second aperture 52 are formed in wall 46 of container 42. In a certain embodiment, first aperture 54 or second aperture temperature 52 are formed in insulator 6, and channels (56, 58) are formed in substrate 4. In a particular embodiment, the analyte is deoxyribonucleic acid (DNA) bonded to working electrode 14 by a sulfide bridge formed by tethering an end of the DNA to working electrode 14 by a terminal thiol group of the DNA.

According to an embodiment, the process includes microfabricating electrochemical article 2 such that electrodes (14, 16, 18), heater 8, and insulator 6 are a product of microfabrication. Microfabrication of electrochemical article 2 provides for a small size of these elements to receive small volumes of the composition, low thermal mass of electrochemical article 2, high heating rate of electrodes (14, 16, 18), low power usage, no thermal crosstalk among electrochemical articles 2 disposed in an array.

Electrochemical article 2 is scalable and can be formed in various sizes or formats, e.g., in arrays. Size L2 of counter electrode can be from 100 μm to 5 mm, specifically from 200 μm to 4 mm, and more specifically from 400 μm to 2 mm. Size L1 of working electrode 14 can be from 33 μm to 2 mm, specifically from 70 μm to 1.3 mm, and more specifically from 130 μm to 700 μm. A thickness of substrate 4 can be from 200 μm to 2 mm, specifically from 350 μm to 1.5 mm, and more specifically from 500 μm to 1 mm. A thickness of heater 8, working electrode 14, counter electrode 16, and reference electrode 18 independently can be from 50 nm to 2 μm, specifically from 100 nm to 1 μm, and more specifically from 200 nm to 500 nm. A transverse width of heater 8, counter electrode 14, reference electrode 18, and wiring (20, 22, 24), can be from 2 μm to 500 μm, specifically from 10 μm to 200 μm, and more specifically from 25 μm to 150 μm. Distance R between working electrode 14 and counter electrode 16 can be from 33 μm to 1.7 mm, specifically from 70 μm to 1.3 mm, and more specifically from 130 μm to 350 μm.

A thickness of insulator 6 can be from 50 nm to 2 μm, specifically from 100 nm to 1 μm, and more specifically from 200 nm to 500 nm. Further, insulator 6 can be selected based on a simple property of the material selected. In an embodiment, insulator 6 or electrochemical article 2 can be subjected to cooling from an external cooler.

Heater 8 provides fast, local temperature control, e.g., temperature or heating rate of working electrode 14, counter electrode 16, and reference electrode 18. A temperature of heater 8 or electrodes (14, 16, 18) can be from −10° C. to 100° C., specifically from 10° C. to 80° C., and more specifically from 20° C. to 70° C. regulated by heat from heater 8, an external cooler, or a combination thereof. A temperature ramp provided to working electrode 14, counter electrode 16, and reference electrode 18 from heater 8 can be from 0.1° C. per second (° C./s) to 50° C./s, specifically from 0.2° C./s) to 20° C./s, and more specifically from 1° C./s) to 5° C./s, e.g., in a presence of the composition disposed on working electrode 14. It is contemplated that a heating rate for a low thermal load such as a gas (e.g., air) can be much faster, e.g., 100° C./s or higher. According to an embodiment, a thermal mass of heater 8, insulator 6, working electrode 14, counter electrode 16, and reference electrode 18 is selected to provide electrochemical article 2 with a selected heating rate and heat exchange rate therebetween.

A volume of the composition received by electrochemical article 2 is effective so that electrochemistry occurs between the analyte and working electrode 14 such that a current that is detectable, e.g., by an ammeter, phase sensitive detector (e.g., a lock-in detector), electrometer, or the like, is produced. It is contemplated that the volume of the composition is from 10 nanoliters (nL) to 50 microliters (μL), specifically from 50 nL to 25 μL, and more specifically from 100 nL to 10 μL. According to an embodiment, electric and poor article 2 can be skilled to receive a greater volume of the composition such as milliliter-sized volumes, e.g., 5 mL.

Electrochemical article 2 has numerous uses including screening for a disease such as by detecting a single nucleotide polymorphism (SNP) in DNA, measuring a protein indicator, and the like. Electrochemical article 2 can be used to perform drug discovery studies such as by electrochemically detecting a binding event that can be associated with a condition change of the analyte, e.g., binding of a small molecules or biologic to the analyte. Additionally, electrochemical article 2 can be used for personal medicine, e.g., by determining a treatment option (e.g., in a clinical environment) or monitoring a therapeutic regimen, e.g., any residential environment by a patient. In manufacturing, electrochemical article 2 can characterize or assess a yield, e.g., for a biologic, or in process monitoring or quality control. Electrochemical article 2 can also provide electrochemical data of the analyte with regard to thermal stressing, biomolecular stability, energetics, kinetics, process pathways, temperature-dependent materials studies, molecular characterization (e.g., determining melting curves), and the like. It is contemplated that a small size and low thermal mass of electrochemical article 2 provide a rapid thermal time constant of electrochemical article 2 for such studies.

According to an embodiment, a process for performing electrochemistry includes introducing the composition (that includes the fluid and the analyte having the electroactive moiety, probe, or first probe) to electrochemical article 2 (including substrate 4, working electrode 14, counter electrode 16, and reference electrode 18, heater 8, and insulator 6 interposed between heater 8 and working electrode 14), transferring a plurality of electrons between working electrode 14 and the electroactive moiety to perform electrochemistry. The process further includes contacting working electrode 14, reference electrode 18, and counter electrode 16 with the composition and adsorbing the analyte on working electrode 14 prior to transferring the plurality of electrons. Also, the process includes heating the analyte to a first temperature and determining a first current at working electrode 14 from exchanging the electrons at the first temperature.

In some embodiments, the process further includes heating the analyte to a second temperature, determining a second current at working electrode 14 from exchanging the electrons at the second temperature, and determining a condition of the analyte from the first current and the second current, wherein the condition comprises a melting temperature, a conformation, a base mismatch, a binding strength, a single nucleotide polymorphism, or a combination comprising at least one of the foregoing conditions.

According to an embodiment, the process also includes introducing a tagant to the composition, interacting the tagant and the analyte (e.g., binding the tagant to the analyte), heating the analyte to the first temperature in presence of the tagant, determining a third current at working electrode 14 from exchanging the electrons at the first temperature in presence of the tagant, heating the analyte to the second temperature in presence of the tagant, determining a fourth current at working electrode 14 from exchanging the electrons at the second temperature in presence of the tagant, and determining the condition of the analyte in the presence of the tagant from the third current and the fourth current. Exemplary tagants include a small molecule (e.g., a cryptolepine or cryptolepine derivative such as N′-(10H-Indolo[3,2-b]quinolin-11-yl)-N,N-dimethyl-propane-1,3-diamine (SYUIQ-5), beta lactam antibiotic, kinase inhibitor, and the like), intercalation compound (e.g., methylene blue, ethidium bromide, doxorubicin, berenil, and the like), dye, thiazole orange, proflavin, and the like.

In an embodiment, transferring electrons between working electrode 14 and the electroactive moiety includes receiving electrons from the electroactive moiety by working electrode 14. In other embodiments, transferring electrons between working electrode 14 and the electroactive moiety includes donating electrons to the electroactive moiety from working electrode 14.

According to an embodiment, a process for performing electrochemistry includes adsorbing a first probe on electrochemical article 2, forming an analyte by contacting the first probe with a second probe comprising an electroactive moiety, transferring a plurality of electrons between working electrode 14 and the electroactive moiety to perform electrochemistry. The process also can include heating the analyte to a first temperature, determining a first current at working electrode 14 from exchanging the electrons at the first temperature, heating the analyte to a second temperature, and determining a second current at 14 working electrode from exchanging the electrons at the second temperature. The process further includes determining a condition of the analyte from the first current and the second current, wherein the condition comprises a melting temperature, conformation or conformation change, base mismatch, binding strength, single nucleotide polymorphism, or a combination comprising at least one of the foregoing conditions. In an embodiment, the process additionally includes interacting a tagant and the analyte, heating the analyte to the first temperature in presence of the tagant, determining a third current at working electrode 14 from exchanging the electrons at the first temperature in presence of the tagant, heating the analyte to the second temperature in presence of the tagant, determining a fourth current at working electrode 14 from exchanging the electrons at the second temperature in presence of the tagant, and determining the condition of the analyte in the presence of the tagant from the third current and the fourth current.

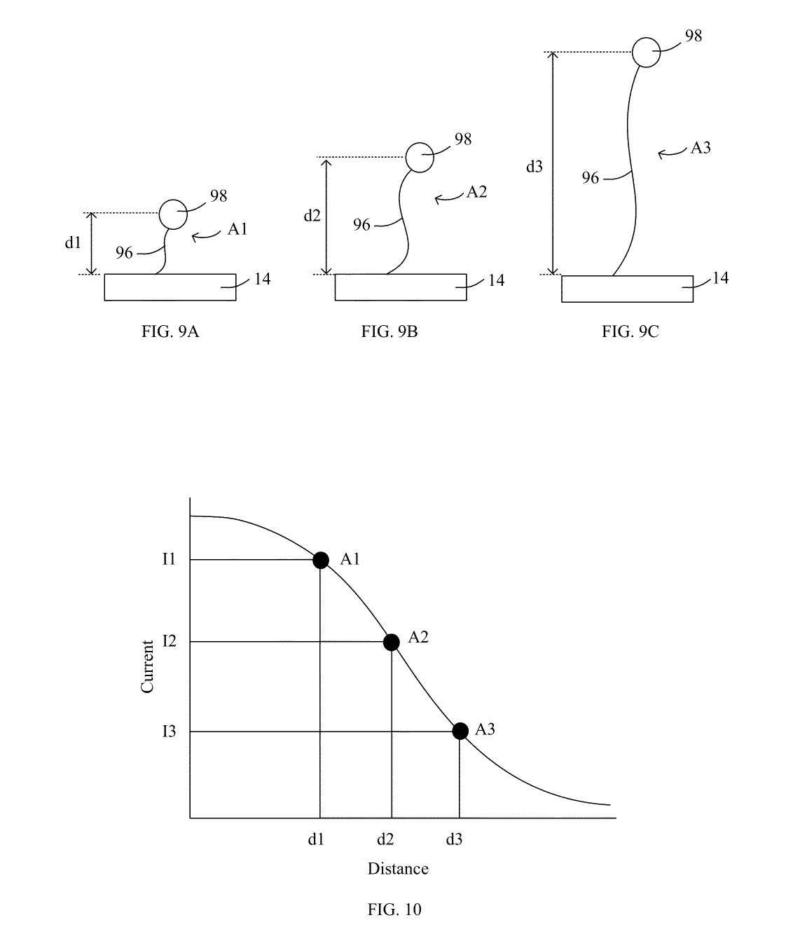

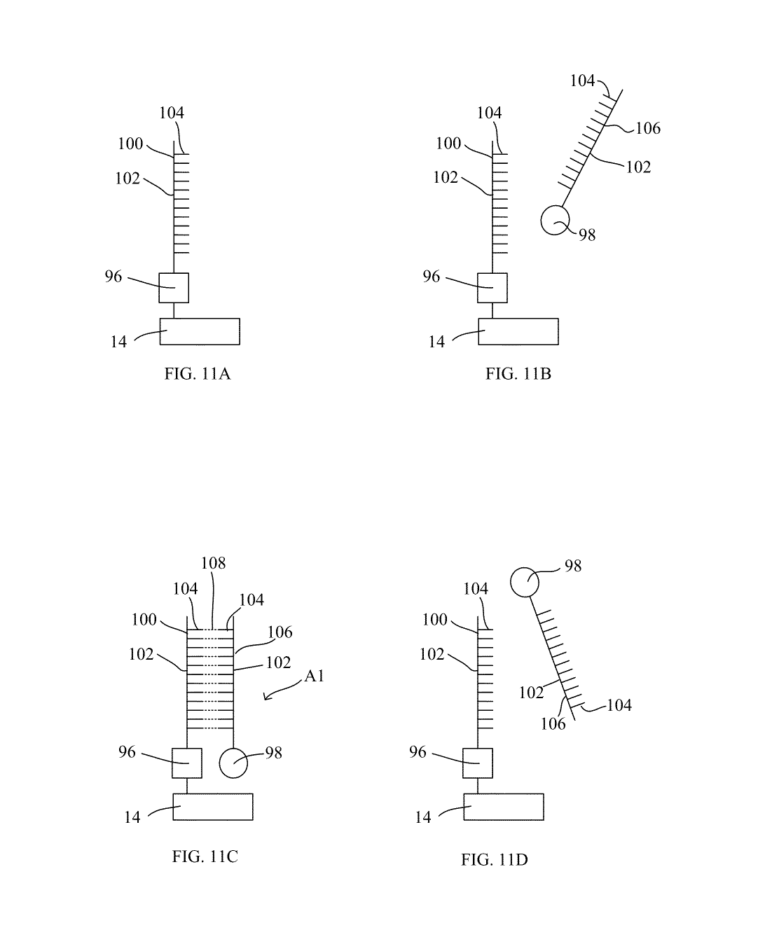

In an embodiment, with reference to FIGS. 9A, 9B, 9C, and 10, first analyte A1 is absorbed on working electrode 14 of electrochemical article 2. Here, first analyte A1 includes linker 96 and electroactive moiety 98, wherein linker 96 binds first analyte A1 to working electrode 14 with a distance of separation between electroactive moiety 98 and reference electrode 14 being first distance D1. Similarly, second analyte A2 is bonded to working electrode 14 (FIG. 9B) with second distance d2, and third analyte A3 is bonded to working electrode 14 (FIG. 9C) with third distance d3. At a selected temperature, electrochemistry is reformed on the analytes (A1, A2, A3), and electrons are transferred from the electroactive moiety 98 of first analyte A1, second analyte A2, third analyte A3 to working electrode 14. FIG. 10 shows a graph of current measured at working electrode 14 versus distances (d1, d2, d3) between reference electrode 14 and electroactive moieties 98. It should be appreciated that electrochemical article 2 can be used measure a current signal representative of a distance (e.g., d1, d2, d3) between electroactive moiety and working electrode 14.

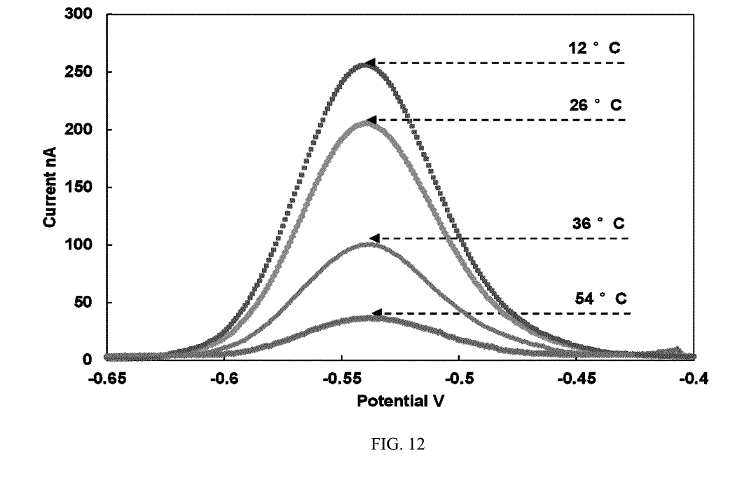

In an embodiment, with reference to FIGS. 11A, 11B, 11C, and 11D, first analyte A1 is formed by disposing first probe 100 on reference electrode 14, introducing second probe 106, and associating second probe 106 to first probe 100 to form first analyte A1. Here, first probe 100 can be a DNA fragment that includes backbone 102, a plurality of nucleobases 104, and linker 96 to bind to working electrode 14. Second probe 106 can be a complementary DNA fragment to first probe 100 and can include electroactive moiety 98. In an absence of electroactive moiety 98 from second probe 106, first probe 100 has negligible exchange of electrons with working electrode 14. In response to associating second probe 106 to first probe 100 at a selected first temperature to form first analyte A1, electroactive moiety 98 is present such that an exchange of electrons occurs between working electrode 14 and electroactive moiety 98. However, heating first analyte A1 to a second temperature that is greater than a melting temperature of first analyte A1, second probe 106 that includes electroactive moiety 98 dissociates from first probe 100 such that current from exchanging electrons with reference electrode again becomes negligible. FIG. 12 shows a graph of current versus potential (i.e., a voltamogram) for various temperatures from which melting curves can be determined for DNA as described in this paragraph. Example 1 includes additional information for FIG. 12.

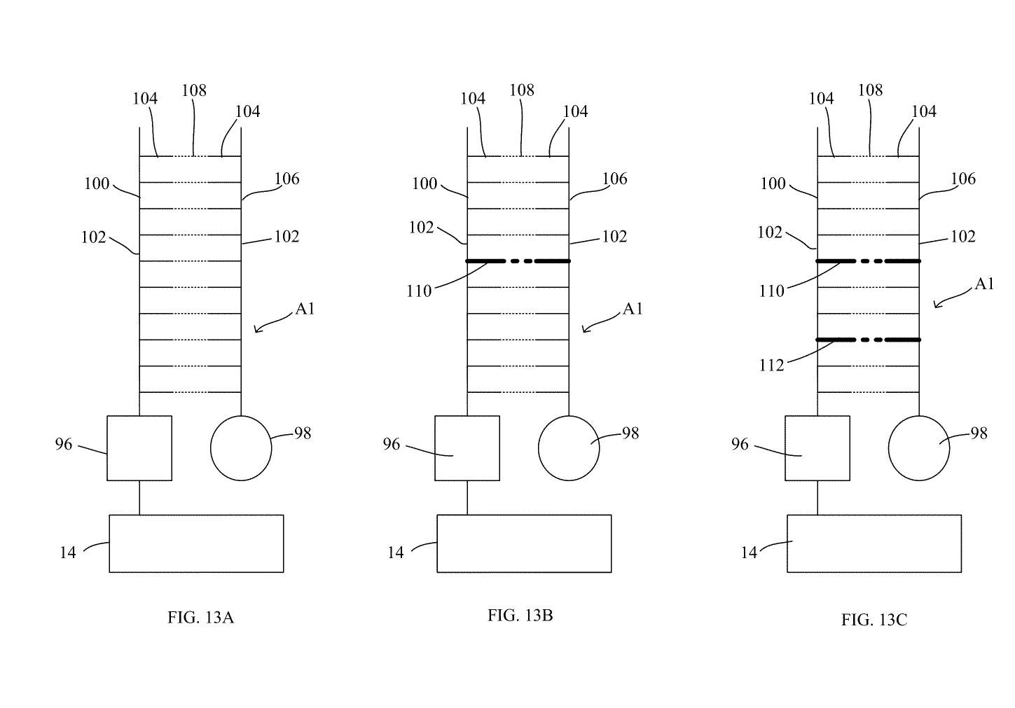

According to an embodiment, with reference to FIGS. 13A, 13B, and 13C, electrochemical article 2 can be used to determine single nucleotide polymorphisms (SNPs) in DNA samples. Here, a melting temperature Tₘ can be determined from the voltamogram for a first DNA sample that does not include a SNP (FIG. 13A), a second DNA sample that includes a single SNP (FIG. 13B), and a third DNA sample that includes two SNPs (FIG. 13C). It should be appreciated that melting curves and corresponding melting temperatures Tₘ for the first DNA sample, second DNA sample, and third DNA sample differ due to inclusion or absence of an SNP.

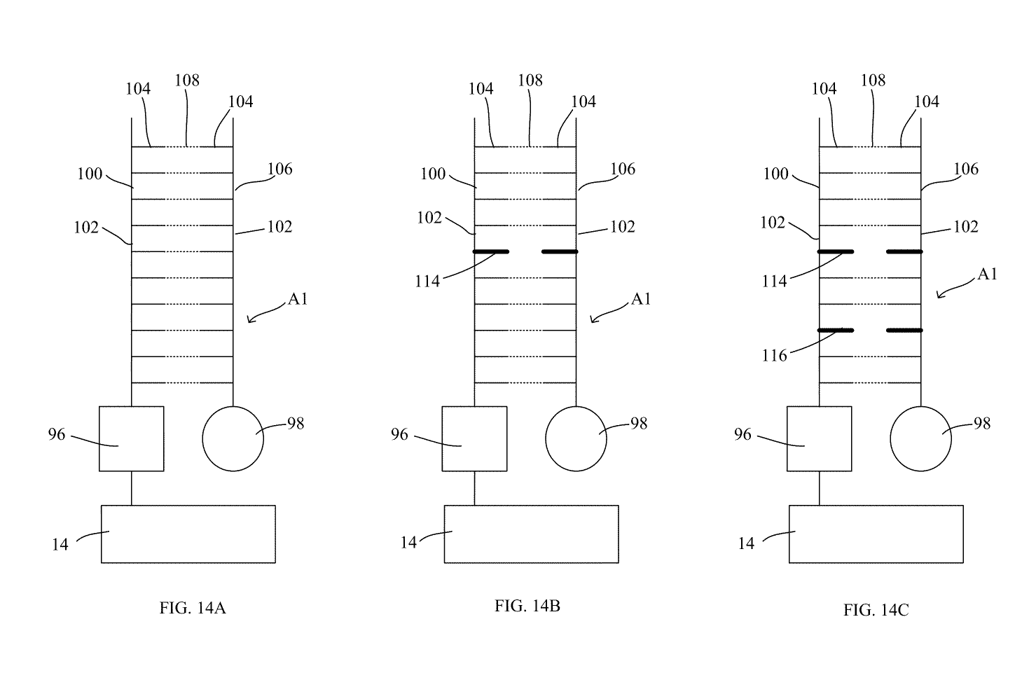

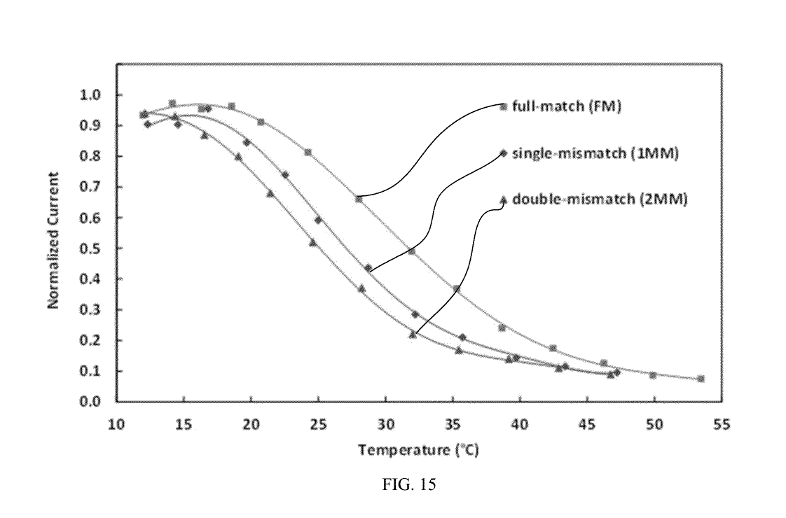

In an embodiment, with reference to FIGS. 14A, 14B, and 14C, electrochemical article 2 can be used to determine a base mismatch, e.g., in a DNA duplex. DNA mismatches include insertion, deletion, or incorrect incorporation of a base in a DNA strand. Mismatched bases can include incorrect pairing among bases in a first DNA strand bound to a second DNA strand such as pairing guanine to thymine or pairing adenine the cytosine. Here, a melting temperature Tₘ of a DNA duplex can be determined from the voltamogram for a first DNA sample that does not include a DNA mismatch (FIG. 14A, a perfect match among bases 104 between first probe 100 and second probe 106), a second DNA sample that includes a single mismatch (FIG. 14B), and a third DNA sample that includes two mismatches (FIG. 14C). It should be appreciated that melting curves and corresponding melting temperatures Tₘ for the first DNA sample, second DNA sample, and third DNA sample differ due to inclusion or absence of an SNP as shown in FIG. 15 for a graph of current versus temperature that includes three curves: a duplex with full match (FM), a single mismatch (SMM), and double mismatch (2MM) amongst nucleobases in respective DNA duplex samples. Example 3 includes additional information for FIG. 15.

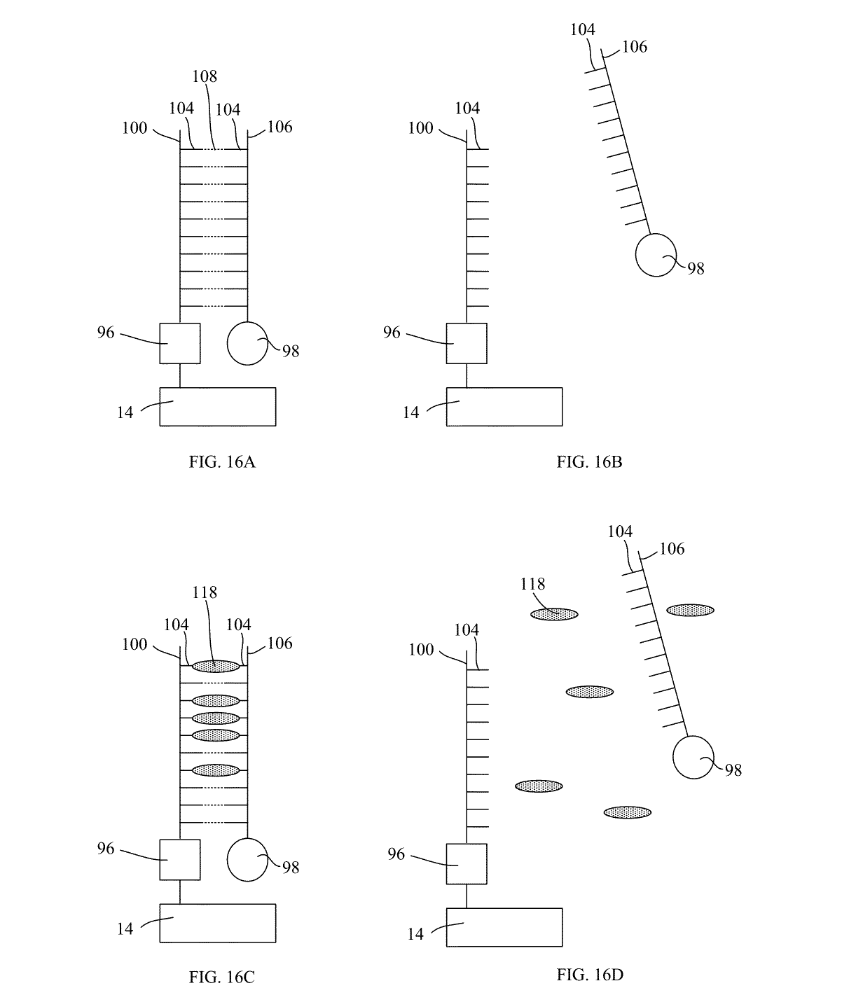

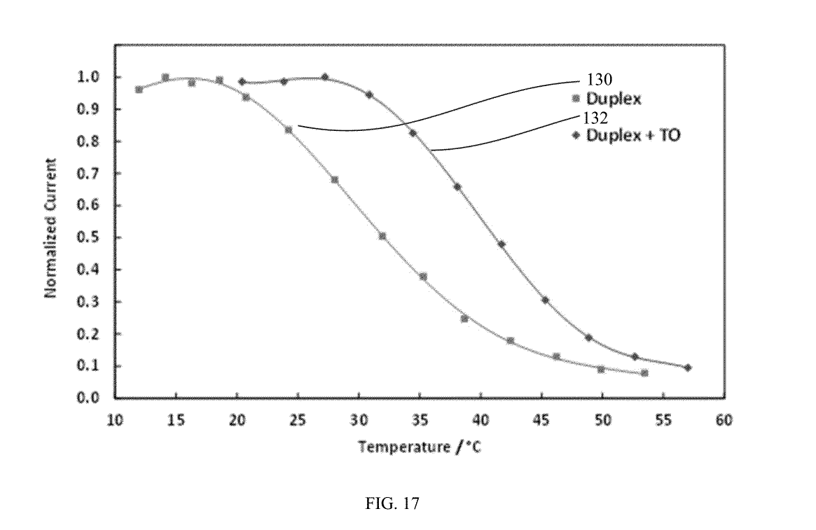

In an embodiment, with reference to FIGS. 16A, 16B, 16C, and 16D, first analyte A1 includes first probe 100 bound to second probe 106 absorbed on reference electrode 14 (FIG. 16A). Heating first analyte A1 to a temperature greater than a melting temperature Tₘ of first analyte A1 dissociates second probe 106 from first probe 100 (FIG. 16B). Here, first probe 100 can be a DNA fragment that includes backbone 102, a plurality of nucleobases 104, and linker 96 to bind to working electrode 14. Second probe 106 can be a complementary DNA fragment to first probe 100 and can include electroactive moiety 98. In a presence of electroactive moiety 98 from second probe 106 in first analyte A1, first analyte A1 exchanges electrons with working electrode 14. In an absence of electroactive moiety 98 from second probe 106, first probe 100 has negligible exchange of electrons with working electrode 14 (FIGS. 16B and 16D). Introducing tagant 118 to first analyte A1, tagant 118 associates with first analyte A1, e.g., with bond 108 (FIG. 16C). The association between tagant 118 and first analyte A1 changes a melting temperature of the tagant-first analyte A1 complex as compared with first analyte A1. When tagant 118 stabilizes first analyte A1 in tagant-first analyte A1 complex, the melting temperature Tₘ increases. When tagant 118 destabilizes first analyte A1 in tagant-first analyte A1 complex, the melting temperature Tₘ decreases. FIG. 17 shows a graph of current versus temperature for a DNA duplex (curve 130) and for the DNA duplex with tagant 118 (curve 132). Example 4 includes additional information for FIG. 17. Tagants can include, e.g., an analytical standard, antibacterial, antibiotic, antiparasitic, antiprotozoal, anthelminthic, biochemical, drug, metabolite, pharmaceutical, stain, dye, and the like. Exemplary tagants include thiazole orange), berenil, and the like.

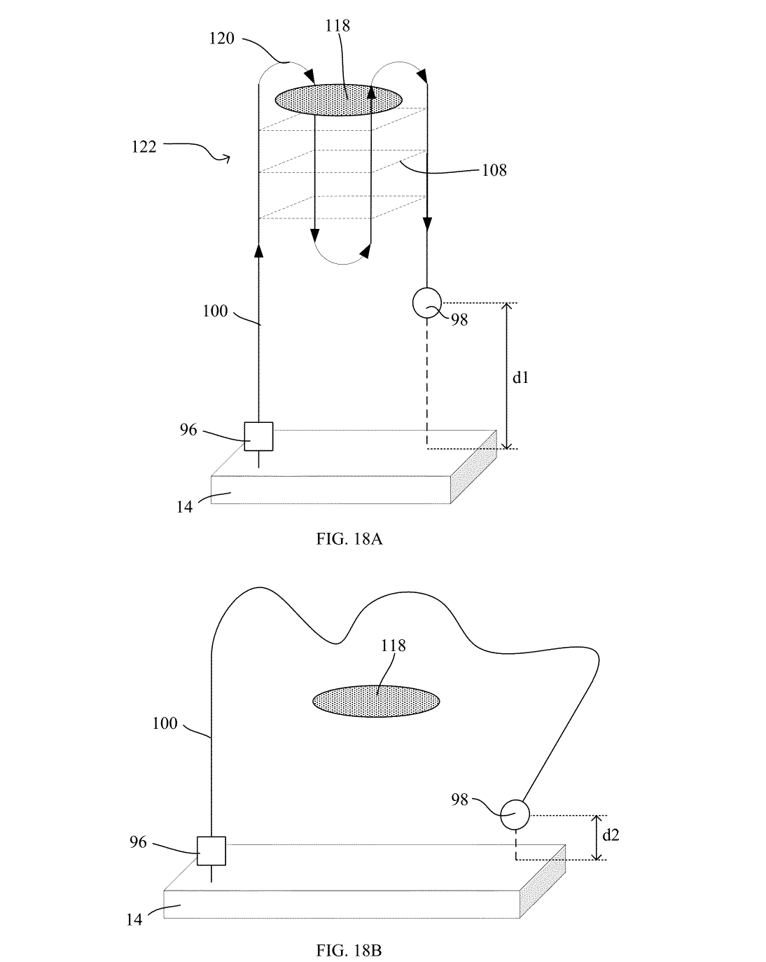

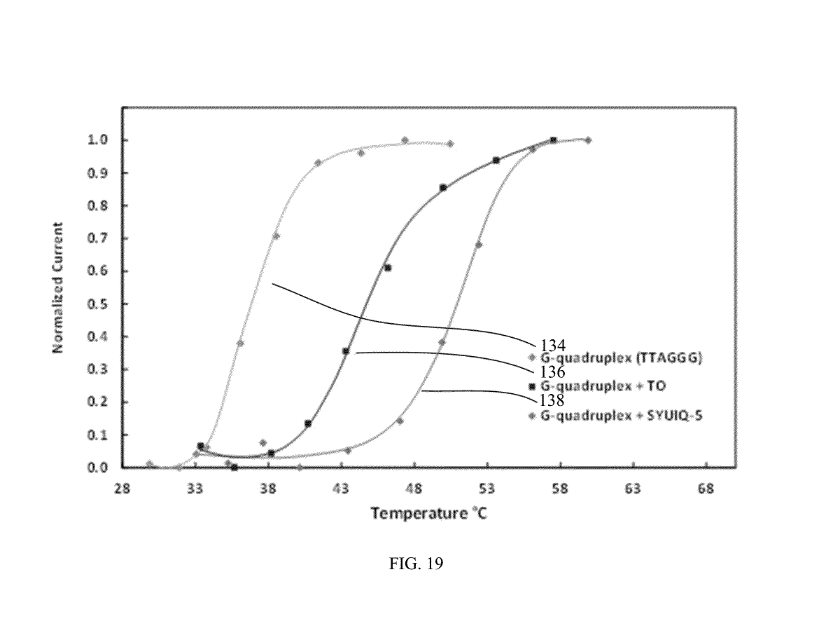

According to an embodiment, with reference to FIGS. 18A and 18B, first analyte A1 includes first probe 100 absorbed on reference electrode 14 (FIG. 18A). Here, first analyte A1 can be a DNA sample with a G-quadruplex 122 having bonds 108 among guanine bases in the quadruplex and turns 120. Bonds 108 in first analyte A1 can associate with tagant 118. Upon heating the tagant-first analyte A1 complex, tagant 118 dissociates from G-quadruplex 122, and first analyte A1 undergoes a confirmation change. As a result, a melting temperature Tₘ changes from that of the tagant-first analyte A1 complex to that of the first analyte A1. Accordingly, determining a melting curves of such samples provides for confirmation and binding information to be ascertained. FIG. 19 shows a graph of current versus temperature for a DNA with a G-quadruplex (curve 134), the G-quadruplex with a first tagant (curve 136), and the G-quadruplex with a second tagant (curve 138). Example 5 includes additional information for FIG. 19. Exemplary tagants include SYUIQ-5_, acridinium salt such as 3,11-difluoro-6,8,13-trimethyl-8H-quino[4,3,2-kl]acridinium methosulfate (RHPS4, a pentacyclic acridinium salt), peptide, and the like.

Electrochemical article 2 has beneficial and advantageous properties. Beneficially, electrochemical article 2 provides determination of current level from electrochemistry between the electroactive moiety of the analyte and working electrode 14 instead of optical-based detection of a condition of the analyte, e.g., conformational change of the analyte. Electrochemical measurement are sensitive and occur in an absence of a polymerase chain reaction (PCR). Moreover, determination of electrochemistry of the analyte occurs in an absence of a fluorescent tag. Electrochemical article 2 is easily integrated into a system due to electronic control and electrical output of signals from electrochemical article 2. Further, lithographic fabrication of electrochemical article 2 produces a plurality of electrochemical articles 2 in an array to provide high throughput or parallel electrochemical experiments. Additionally, a surface area and compactness of electrodes (14, 16, 18) receive small volumes (e.g., from 80 nL (or less) to 20 mL) of the composition. In an array of electrochemical articles 2, individual electrochemical articles 2 are independently addressable for electrical communication or fluid communication therewith. Furthermore, electrochemical article 2 can be subjected to rapid thermal programming by heating with heater 8, e.g., with a time to obtain a constant temperature of electrodes (14, 16, 18) from less than one second to five seconds between subsequent electrochemical measurements of the analyte. Also, electrochemical article 2 is configured for controlling temperature or a speed of a temperature ramp provided by heater 8. Consequently, electrochemical article 2 can be used in determination of kinetics, thermal stressing, interaction pathways of the analyte, and the like.

The articles and processes herein are illustrated further by the following Examples, which are non-limiting.

### EXAMPLES

### Example 1

### Measuring a Voltamogram of an Analyte

An electrochemical article was made that included a gold working electrode, a counter electrode, a reference electrode, and heater disposed on a substrate. The electrochemical article was cleaned before being subjected to DNA self-assembly on the working electrode using a procedure that began by incubating the Au electrode with 50 mmol/L H₂SO₄. Then twenty cycles of cyclic voltammetry were run from 1.0 V to −0.1 V with a sample interval of 0.001 V. After the cleaning, 1 μL of 200 μmol/L of the immobilization probe (5′-S-S-(C₆H₁₂)-TTT ACC TTT ATT-3′) was mixed with 2 μL of 10 mmol/L TCEP at room temperature in the dark for 45 minutes. The solution was then diluted to a concentration of 2 μmol/L with 100 μL PBS buffer (10 mmol/L phosphate-buffered saline pH 7.4 with 1 mol/L NaCl and 1 mmol/L Mg²⁺). The Au electrode was incubated with 2 μmol/L immobilization probe in 10 μL PBS for 30 mins in the dark. After rinsing with deionized water, followed by drying with a nitrogen gun, the electrodes were incubated in 2 mmol/L 6-mercaptohexanol solution for 1 hour at room temperature, in the dark. The electrode was rinsed for 1 minute using deionized water to remove any remaining 6-mercaptohexanol solution. The electrode was again dried using a nitrogen. To allow hybridization interactions, the PDMS cell was filled with PBS buffer (10 μL) containing 2 μmol/L hybridization probe (3′-(MB)-AAA TGG AAA TAA CC-5′) and left to stand for 30 mins to allow for hybridization with the analyte, after which electrochemical melting curve measurements were taken. The electrochemical measurements were performed with an electrochemical workstation. During these measurements, sample temperature was controlled and monitored using a source meter. The three electrodes and Pt heater were connected to the potentiostat and source meter, respectively. The temperature was increased in 3° C. increments using 5 seconds to reach thermal equilibrium and then 15 seconds to obtain the square wave voltammetry (SWV) scan on the Au electrode for that temperature. SWV was carried out in all studies from −0.2 V to −0.7 V with 0.001 V interval, 60 Hz frequency and 0.025 amplitude. The sequence was repeated until the end of the melting curve measurements.

FIG. 12 shows a graph of current versus potential for methylene blue-DNA conjugate immobilized on the gold electrode. The current decreased as temperature was increased because the methylene blue probe dissociated and moved away from the electrode surface.

### Example 2

### Stability of Electrochemical Measurements of Analytes

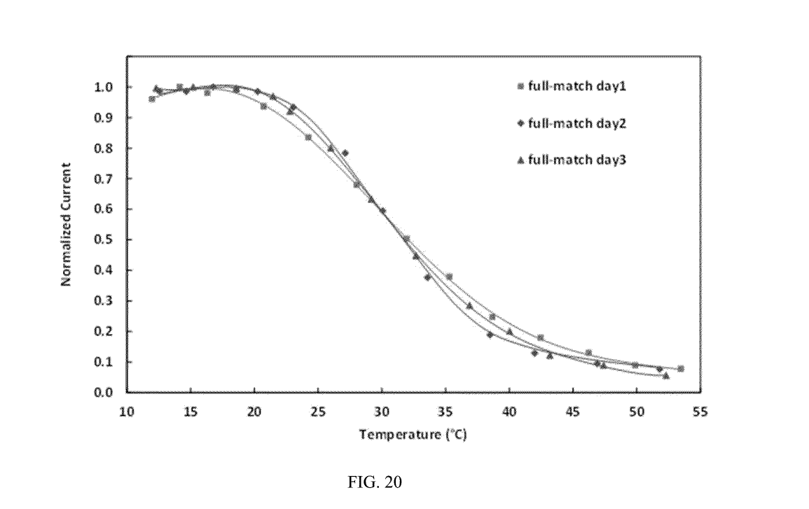

The experimental procedure was the same as described in Example 1 and repeated on three separate days on the same electrochemical article. FIG. 20 shows a graph of current versus temperature for methylene blue-DNA conjugate immobilized on the gold working electrode on different days. The melting temperatures obtained on different days are similar.

### Example 3

### DNA Mismatches

The electrochemical article described in Example 1 was used to acquire data for DNA mismatches. The gold electrodes were cleaned before being subjected to a composition for electrochemistry. After the cleaning, 1 μL of 200 μmol/L of an immobilization probe (5′-S-S-(C₆H₁₂)-TTT ACC TTT ATT-3′ for full match, 5′-SH-(C₆H₁₂)-TTT ACG TTT ATT-3′ for single mismatch, or 5′-SH-(C₆H₁₂)-TTT AGG TTT ATT-3′ for double mismatch) was mixed with 2 μL of 10 mmol/L TCEP at room temperature in the dark for 45 minutes. This solution was then diluted to a concentration of 2 μmol/L with 100 μL PBS buffer (10 mmol/L phosphate-buffered saline pH 7.4 with 1 mol/L NaCl and 1 mmol/L Mg²⁺). The Au electrode was incubated with 2 μmol/L immobilization probe in 10 μL PBS for 30 minutes in the dark. After rinsing with deionized water, followed by drying with a nitrogen gun, the electrodes were incubated in 2 mmol/L 6-mercaptohexanol solution for 1 hour at room temperature in the dark. The electrode was rinsed for 1 minute using deionized water to remove remaining 6-mercaptohexanol solution. The electrode was again dried using a nitrogen. To allow hybridization interactions, the PDMS cell was filled with PBS buffer (10 μL) containing 2 μmol/L hybridization probe (3′-(MB)-AAA TGG AAA TAA CC-5′) and left to stand for 30 minutes to hybridize with the analyte after which electrochemical melting curve measurements were performed.

FIG. 15 shows a graph of current versus temperature for a methylene blue containing immobilized DNA duplex. The melting temperature of fully matched duplex was different from a duplex containing a mismatch such that the electrochemical article is useful to detect a SNP.

### Example 4

### Tagant Binding

The electrochemical article described in Example 1 was used to acquire data for tagant binding. Here, the gold reference electrode was cleaned and incubated with 2 μmol/L immobilization probe (5′-S-S-(C₆H₁₂)-TTT ACC TTT ATT-3′) in 10 μL PBS for 30 mins in the dark. After rinsing with deionized water, followed by drying with a nitrogen gun, the electrodes were incubated in 2 mmol/L 6-mercaptohexanol solution for 1 hour at room temperature, in the dark. The electrode were rinsed for 1 minute using deionized water to remove any remaining 6-mercaptohexanol solution. The electrodes were again dried using nitrogen. For hybridization interactions, the PDMS cell disposed as a container in the electrochemical article was filled with PBS buffer (10 μL) containing 2 μmol/L hybridization probe (3′-(MB)-AAA TGG AAA TAA CC-5′) and thiazole orange (14 μmol/L) and left to stand for 30 mins to allow for hybridization with the analyte after which the electrochemical melting curve measurements were taken. FIG. 17 shows a graph of current versus temperature for an immobilized DNA-methylene blue conjugate in the presence or absence of thiazole orange. Intercalation of thiazole orange into the DNA increased the melting temperature such that the electrochemical article can be used to determine affinity of a small molecule to a macromolecular receptor.

### Example 5

### Tagant Binding

The electrochemical article described in Example 1 was used to acquire data for tagant binding. Here, 1 μL of 200 μmol/L 5′ thiolated and 3′ redox MB labelled G-quadruplex (5′-S-S-(C₆H₁₂)-(TTAGGG)₄-MB-3′) was mixed with 2 μL of 10 mmol/L TCEP at room temperature in the dark for 45 min. The solution was then diluted to a concentration of 2 μmol/L with 100 μL PBS buffer (10 mmol/L phosphate-buffered saline pH 7.4 with 1 mol/L NaCl and 1 mmol/L Mg²⁺). The Au working electrode was incubated with 2 μmol/L G-quadruplex in 10 μL PBS for 30 min in the dark. After rinsing with deionized water, followed by drying with a nitrogen gun, the electrodes were incubated in 2 mmol/L 6-mercaptohexanol solution for 1 h at room temperature in the dark. The electrodes were rinsed for 1 min using deionized water to remove remaining 6-mercaptohexanol solution. The electrodes were again dried using a nitrogen gun. The PDMS container was filled with PBS buffer (10 μt) and left to stand for 30 minutes in an insulated box held at room temperature after which the electrochemical melting curve measurements were taken. A similar preparation was used for G-quadruplex melting measurement in the presence of TO or SYUIQ-5. For G-quadruplex binding ligands (TO or SYUIQ-5) to be bound to the G-quadruplex, the PDMS chamber was filled with PBS buffer (10 μL) containing 2 μmol/L binding ligands (TO or SYUIQ-5) and left to stand for 30 min in an insulated box held at room temperature. Electrochemical melt curve measurements were then taken.

FIG. 19 shows a graph of current versus temperature for methylene blue-labeled G-quadruplex in presence or absence of ligands. G-quadruplex interactive ligands increased the melting temperature of the G-quadruplex such that the electrochemical article can be used to determine the affinity of a ligand for a G-quadruplex receptor.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

Reference throughout this specification to “one embodiment,” “particular embodiment,” “certain embodiment,” “an embodiment,” or the like means that a particular feature, structure, or characteristic described in connection with the embodiment is included in at least one embodiment. Thus, appearances of these phrases (e.g., “in one embodiment” or “in an embodiment”) throughout this specification are not necessarily all referring to the same embodiment, but may. Furthermore, particular features, structures, or characteristics may be combined in any suitable manner, as would be apparent to one of ordinary skill in the art from this disclosure, in one or more embodiments.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix “(s)” as used herein is intended to include both the singular and the plural of the term that it modifies, thereby including at least one of that term (e.g., the colorant(s) includes at least one colorants). “Optional” or “optionally” means that the subsequently described event or circumstance can or cannot occur, and that the description includes instances where the event occurs and instances where it does not. As used herein, “combination” is inclusive of blends, mixtures, alloys, reaction products, and the like.

As used herein, “a combination thereof” refers to a combination comprising at least one of the named constituents, components, compounds, or elements, optionally together with one or more of the same class of constituents, components, compounds, or elements.

All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” Further, the conjunction “or” is used to link objects of a list or alternatives and is not disjunctive; rather the elements can be used separately or can be combined together under appropriate circumstances. It should further be noted that the terms “first,” “second,” “primary,” “secondary,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

What is claimed is:

1. An electrochemical article comprising:
a substrate;
a working electrode disposed on the substrate to contact a composition comprising:
a fluid; and
an analyte to adsorb to the working electrode and comprising an electroactive moiety, the working electrode being configured to receive a plurality of electrons from the electroactive moiety, to donate electrons to the electroactive moiety, or a combination comprising at least one of the foregoing exchanges of electrons with the electroactive moiety;
a reference electrode disposed on the substrate to contact the composition;
a counter electrode disposed on the substrate to contact the composition;
a heater disposed on the substrate to heat the analyte adsorbed on the working electrode to a selected temperature; and
an electrically insulating layer interposed between the heater and the working electrode, the electrochemical article being microfabricated.

2. The electrochemical article of claim 1, further comprising a container disposed on the substrate to receive and to hold the composition in contact with the working electrode, the reference electrode, and the counter electrode.

3. The electrochemical article of claim 2, further comprising a fluid delivery system in fluid communication with the container to deliver the composition to the container.

4. The electrochemical article of claim 3, further comprising a microfluidic system comprising:
the container; and
the fluid delivery system,
the microfluidic system being configured to deliver a microfluidic volume of the composition to the working electrode, the reference electrode, and the counter electrode.

5. The electrochemical article of claim 1, further comprising:
a first power source in electrical communication with the heater to provide power to the heater to control the heat supplied to the analyte; and
a second power source in electrical communication with the working electrode to provide power to the reference electrode.

6. The electrochemical article of claim 1, wherein the working electrode comprises a gold surface.

7. The electrochemical article of claim 1, further comprising the composition, and a volume of the composition is less than 500 nanoliters.

8. An electrochemical article comprising:
a substrate;
a working electrode disposed on the substrate to contact a composition comprising:
a fluid; and
an analyte to adsorb to the working electrode and comprising an electroactive moiety, the working electrode being configured to receive a plurality of electrons from the electroactive moiety, to donate electrons to the electroactive moiety, or a combination comprising at least one of the foregoing exchanges of electrons with the electroactive moiety;
a reference electrode disposed on the substrate to contact the composition;
a counter electrode disposed on the substrate to contact the composition;
a heater disposed on the substrate to heat the analyte adsorbed on the working electrode to a selected temperature;
an electrically insulating layer interposed between the heater and the working electrode, the electrochemical article being microfabricated; and
a microfluidic system comprising:
a container disposed on the substrate to receive and to hold the composition in contact with the working electrode, the reference electrode, and the counter electrode; and
a fluid delivery system in fluid communication with the container to deliver the composition to the container,
the microfluidic system being configured to deliver a microfluidic volume of the composition to the working electrode, the reference electrode, and the counter electrode.

9. A process for performing electrochemistry, the process comprising:
introducing a composition to an electrochemical article that comprises:
a substrate;
a working electrode disposed on the substrate, the composition comprising:
a fluid; and
an analyte comprising an electroactive moiety;
a reference electrode disposed on the substrate;
a counter electrode disposed on the substrate;
a heater disposed on the substrate; and
an electrically insulating layer interposed between the heater and the working electrode; and
transferring a plurality of electrons between the working electrode and the electroactive moiety to perform electrochemistry.

10. The process of claim 9, further comprising:
contacting the working electrode, the reference electrode, and the counter electrode with the composition; and
adsorbing the analyte on the working electrode prior to transferring the plurality of electrons.

11. The process of claim 10, further comprising:
heating the analyte to a first temperature; and
determining a first current at the working electrode from exchanging the electrons at the first temperature.

12. The process of claim 11, further comprising:
heating the analyte to a second temperature; and
determining a second current at the working electrode from exchanging the electrons at the second temperature.

13. The process of claim 12, further comprising determining a condition of the analyte from the first current and the second current,
wherein the condition comprises a melting temperature, a conformation, a base mismatch, a binding strength, a single nucleotide polymorphism, or a combination comprising at least one of the foregoing conditions.

14. The process of claim 12, further comprising:
introducing a tagant to the composition;
interacting the tagant and the analyte;
heating the analyte to the first temperature in presence of the tagant;
determining a third current at the working electrode from exchanging the electrons at the first temperature in presence of the tagant;
heating the analyte to the second temperature in presence of the tagant;
determining a fourth current at the working electrode from exchanging the electrons at the second temperature in presence of the tagant; and
determining the condition of the analyte in the presence of the tagant from the third current and the fourth current.

15. The process of claim 9, wherein transferring electrons between the working electrode and the electroactive moiety comprises receiving electrons from the electroactive moiety by the working electrode.

16. The process of claim 9, wherein transferring electrons between the working electrode and the electroactive moiety comprises donating electrons to the electroactive moiety from the working electrode.

17. A process for performing electrochemistry, the process comprising:
adsorbing a first probe on an electrochemical article comprising:
a substrate;
a working electrode disposed on the substrate;
a reference electrode disposed on the substrate;
a counter electrode disposed on the substrate;
a heater disposed on the substrate opposing the working electrode, the reference electrode, and the counter electrode; and
an electrically insulating layer interposed between the heater and the working electrode;
forming an analyte by contacting the first probe with a second probe comprising an electroactive moiety; and
transferring a plurality of electrons between the working electrode and the electroactive moiety to perform electrochemistry.

18. The process of claim 17, further comprising:
heating the analyte to a first temperature;
determining a first current at the working electrode from exchanging the electrons at the first temperature;
heating the analyte to a second temperature; and
determining a second current at the working electrode from exchanging the electrons at the second temperature.

19. The process of claim 18, further comprising determining a condition of the analyte from the first current and the second current,
wherein the condition comprises a melting temperature, a conformation, a base mismatch, a binding strength, a single nucleotide polymorphism, or a combination comprising at least one of the foregoing conditions.

20. The process of claim 19, further comprising:
interacting a tagant and the analyte;
heating the analyte to the first temperature in presence of the tagant;
determining a third current at the working electrode from exchanging the electrons at the first temperature in presence of the tagant;
heating the analyte to the second temperature in presence of the tagant;
determining a fourth current at the working electrode from exchanging the electrons at the second temperature in presence of the tagant; and
determining the condition of the analyte in the presence of the tagant from the third current and the fourth current.
